(19) United States
(12) Patent Application Publication
(10) Pub. No.: US 2003/0077065 A1
(43) Pub. Date: Apr. 24, 2003

(54) Service data delivery system

(75) Inventors: Liesbeth M. Scholten, Eindhoven (NL); Paul J. Rankin, Horley (GB); Timothy J. Everett, Thakeham (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/270,301

(22) Filed: Oct. 11, 2002

(30) Foreign Application Priority Data
Oct. 18, 2001 (GB) 0125018.2

(51) Int. Cl. H04N 5/76; H04N 5/781

(52) U.S. Cl. 386/46; 386/125

(57) ABSTRACT

A method and system for the enabling of access to data services, together with devices, record carriers and signal formats for use with the same, comprises a consumer electronics device (14) arranged to receive content (24) and operable (36, 72) to present the same to a user; and a portable communications device (18) configured both for communications (70) and to access (50, 62) data services. Various means (40, 16, 48) are provided for transmitting data from the consumer electronics device (14) to the portable communications device (18). One or more services related to the content received by the consumer electronics device are provided (20), with connection data (26) for the service or services being delivered to the consumer electronics device (14) in conjunction with the content (24). The connection data is transmitted therefrom to the portable communications device (18), with the portable communications device being operable to establish a connection (22) to access the service or services at least partially in dependence on the connection data.

The present invention relates to methods and apparatuses for delivering to a user of a data processing and/or presentation device presenting received content to a user, ancillary data identifying sources of additional information, facilities or services contextually related to the presented content.

In particular, although not exclusively, the invention relates to methods and apparatus configurations by means of which ancillary data, relating to content handled by a consumer audio and/or video data handling system of a user, is delivered or made available to a portable communications device of that user.

The data processing and/or presentation device may comprise, for example, a television, set-top box, radio receiver, video cassette recorder, a CD or DVD player, and the received content may comprise audio, video or other data content in encoded or unencoded form, as dictated by user selection and/or preference, or by constraints of the apparatus involved. Whilst the foregoing are described generically herein as consumer electronics or presentation devices and presented content (or content for presentation, as appropriate), it will be recognised that this list is not limiting, that other device and/or content forms may be utilised, and that the term consumer electronics device does not exclude similar devices of so-called professional quality (e.g. audio, video or data handling devices for studio or scientific applications): some further examples are given in the following description of embodiments of the invention. Similarly, the term “portable communications device” as used herein will be understood to include, without limitation, personal and/or mobile telephone, PDA with appropriate communications facility, personal mobile radio and the like, as well as portable devices configured for data transmission and/or reception, such as remote controls and portable MP3 or video players.

The above-mentioned additional information, facilities or services may comprise, for example, data relating to cast, crew or authors for television programmes or movies, information on other recordings by a musician, information on where/how a user may obtain related works for an audio/video presentation, details of public or private services relating to presented content (such as contact details for a medical charity accompanying a television programme relating to a specific ailment), and other public service or advertising material linked to presented content. As above, whilst the foregoing will be described generically herein as ancillary data, for the purposes of clarity only, the term should not be construed as limited to the examples given above, or to further examples given in the following description of preferred embodiments of the invention.

One example of a system for the delivery of contextually related ancillary data is described in the commonly-assigned International patent application no. WO 01/78484 filed Apr. 9, 2001 with a priority date of Apr. 15, 2000 and unpublished at the priority date of the present application. In the system described, a networked communications apparatus comprises at least one server and a plurality of user terminals, together with a portable communications device co-operating with one or more of the user terminals. The coupling between terminal (which may comprise a cable-access television or internet-capable PC) and communications device (which may be a portable telephone or PDA with appropriate communications facility) is by wireless transmission. The portable communications device means for receiving wireless transmissions from the terminal are further configured to receive additional data transmitted wirelessly from other sources, such as message delivery beacons distributed in the locality. The system described is primarily concerned with providing (via the mobile device communications network) a back-channel for communicating user data to the content supplier, such as to enable user profiling and, ultimately, tailoring of the delivered content, as well as a means for tailoring ancillary data to provided or made available to the user of the mobile. To this latter end, the terminal may wirelessly broadcast gathered data about user preferences (the identity of a CD being played by the terminal is the example given) which is combined with related information in the mobile (for example, the number of a telephone music service) and which in turn leads to the customising of the service provided to the mobile (primarily making available music deemed likely to appeal to the user).

A problem with such an arrangement is the requirement for the terminal or other user equipment to be configured to derive user data from current settings or operation. Whilst one approach might be to provide a means whereby the user could enter certain profile or other control data (to be wholly or partially reproduced when used in conjunction with setting service parameters for the mobile or other user terminal), an unacceptable degree of additional complexity still results for the terminal.

It is accordingly an object of the invention to provide an improved means for the provision of ancillary data

In accordance with a first aspect of the present invention, there is provided a method for the enabling of user access to data services by a portable communications device configured both for communications and to access such data services, wherein a consumer electronics device is arranged to receive content and present the same to a user; and wherein one or more services related to said content received by said consumer electronics device are provided, with connection data for said service or services being delivered to said consumer electronics device in conjunction with said content, said connection data being transmitted therefrom to said portable electronics device, and said portable communications device being thereby enabled to establish a connection to said service or services at least partially in dependence on said connection data.

By having the connection data provided in conjunction with the content (suitably embedded therein) but not inextricably written as a part of that content, periodic updates or changes to that connection data, for example to reflect a change in the server or other mechanism hosting the data services, may be simply accommodated by the data service provider without requiring amendment or alteration of the content itself.

In one embodiment to be described, the connection data is passed transparently through said consumer electronics device to said portable communications device such that, not only does the content not require alteration in response to changes in the connection data, the consumer electronics device further requires no reconfiguration. In an alternative embodiment, the connection data may be supplemented in the consumer electronics device prior to being passed to said portable communications device: in the example of a television receiver as the consumer electronics device, the supplementary data added to the connection data in the consumer electronics device may comprise, for example, an indication of the television channel currently being viewed by a user.

The content and service data may be stored in the consumer electronics device following receipt thereof, with that connection data being transmitted to said portable device on reading of said content and service data from storage: where the consumer electronics device is a video recorder, for example, the connection data relating to data services which in turn relate to received content is recorded together with that content, and output to the portable communications device on playback of the stored content.

According to a another aspect of the present invention there is provided a system for the enabling of access to data services, comprising:

a consumer electronics device arranged to receive content and operable to present the same to a user; and

a portable communications device configured both for communications and to access data services, with the system including means for transmitting data from said consumer electronics device to said portable device;

wherein one or more services related to said content received by said consumer electronics device are provided, with connection data for said service or services being delivered to said consumer electronics device in conjunction with said content, said connection data being transmitted therefrom to said portable electronics device, and said portable communications device being operable to establish a connection to access said service or services at least partially in dependence on said connection data. As above, in one embodiment, the connection data may be embedded in the content.

In such a system, the means for transmitting data from the consumer electronics device to the portable device may be a fixed connection, but is preferably a wireless link, for example an infra-red link, or an r.f. link and, in the latter case, data transmission on the wireless link suitably conforms to predetermined communications protocols, such as Bluetooth, IEE802.11, 801.15, RF Lite, etc.

In such a system, the consumer electronics device may be configured to filter said connection data on the basis of preset criteria and pass to the portable communications device only such of said connection data as meets said criteria. Such preset criteria may comprise data defining a profile of a user of the system, or may comprise temporal or geographical restriction on which data may be passed to the portable device. Where the consumer electronics device includes a source of time and/or date information, the preset criteria for at least some received connection data may comprise a time/date window outside which the connection data is not transmitted to the portable communications device: where the consumer electronics device has access to a source of data defining the geographical location thereof, the preset criteria for at least some received connection data may comprise a specified area within which the consumer electronics device is to be located if said connection data is to be transmitted to the portable communications device.

In a further aspect of the present invention there is provided a consumer electronics device for use in a system for the enabling of access to data services, comprising said consumer electronics device arranged to receive content and operable to present the same to a user, and a portable communications device configured both for communications and to access data services, with the consumer electronics device including means for transmitting data therefrom to said portable device;

wherein one or more services related to said content received by said consumer electronics device are provided, with connection data for said service or services being delivered to said consumer electronics device in conjunction with said content, said consumer electronics device being configured to transmit said connection data therefrom to said portable electronics device.

The consumer electronics device may take any of a number of forms, as will be appreciated. It may, for example, be configured as a broadcast receiver or set-top box, with the connection data embedded in a broadcast signal carrying that content and received by the device. With the consumer electronics device so configured, the connection data may be embedded in a broadcast television signal carrying broadcast content: the connection data may be carried in the vertical blanking interval portion of such a broadcast television signal, or may be embedded in teletext data accompanying the signal. Where the signal is a broadcast television signal, the consumer electronics device may be terrestrial, cable, or satellite television broadcast receiver.

In an alternative form, the above-mentioned broadcast receiver may be configured as a radio receiver, with the connection data embedded in a broadcast audio and data signal carrying broadcast content received by the device. In such a case, the broadcast audio and data signal may be an FM radio broadcast signal accompanied by RDS data, with the connection data embedded in said RDS data.

In a further alternative form, the consumer electronics device may be configured as a personal computer with the content comprising program data for running by said personal computer. In such a case, the content may be delivered via a network connection or by a removable record carrier: such a removable record carrier may be an optical disc with the connection data embedded in content data carried thereon, or carried thereon at a distinct location separate from said content. The content may comprise one or more web pages.

In a yet further alternative form, the consumer electronics device may be configured as an optical disc player, arranged to extract said connection data from a received optical disc, suitably those formatted according to CD, CD-R, DVD, or like standards.

According to a yet further aspect of the present invention there is provided a portable communications device for use in a system for the enabling of access to data services by said device, and comprising a consumer electronics device arranged to receive content and operable to present the same to a user, and said portable communications device configured both for communications and to access data services, with said portable communications device including means for receiving data transmitted from said consumer electronics device thereto;

wherein one or more services related to said content received by said consumer electronics device are provided, with connection data for said service or services being delivered to said consumer electronics device in conjunction with said content, said connection data being transmitted therefrom to said portable electronics device, and said portable communications device being operable to establish a connection to access said service or services at least partially in dependence on said connection data.

The connection data may either directly identify a provider of data services, or may comprise an identifier for a location from which further data specifying a connection location through which enabling data for access to said data services may be obtained: in this way, changes to the address or other connection data for a service provider can be handled at the connection location (i.e. an intermediary stage) without requiring changes to the connection data provided in conjunction with the content. Where the portable communications device is configured as a portable telephone, the connection data may comprise a telephone number or, where the device further comprises means enabling internet access, the connection data may comprise a Uniform Resource Locator.

A portable communications device as recited suitably includes user-operable input means, with the device configured to access the data services in response to a predetermined user input via said user input means. Such device may be configured to generate and present to a user a menu of user-selectable options related to said data services with the aforesaid predetermined user input comprising selection of an item from said menu. Alternatively, the device may be configured to automatically access the data services in response to receipt of the connection data from the consumer electronics device if one or more predetermined conditions are met. Where the device further comprises memory means holding profile data related to a user, the or one of the aforesaid predetermined conditions to be met may be the matching of at least a part of the connection data with one or more aspects of the stored profile of said user. In such an arrangement, the device may include means to receive said profile data transmitted from the consumer electronics device, or may include monitoring means arranged to generate the profile of the user based on a history of past interactions by the user with one or more of the data services. In a further arrangement, the device may further comprise memory means holding a list of identifiers for respective data services accessible by the device, wherein the or one of the predetermined conditions to be met is the matching of at least a part of the connection data with an identifier stored in said list.

As for the consumer electronics device recited above, the portable communications device may be configured to filter said connection data on the basis of preset criteria and to access only those of said service or services for which said connection data meets those criteria. Where the portable communications device includes a source of time and/or date information, the preset criteria for at least some received connection data may comprise a time/date window outside which said service or services are not accessed. Alternatively, or additionally, where the portable communications device has access to a source of data defining the geographical location thereof (for example an integral GPS receiver or other location determining means), the preset criteria for at least some received connection data may comprise a specified area within which the portable communications device is to be located if said service or services are to be accessed.

The portable communications device may be configured as a portable telephone or radio, or may be configured as a remote controller for the consumer electronics device, or as a personal digital assistant (PDA) with communications facilities for accessing the internet, with the connection data specifying one or more Uniform Resource Locators for respective web sites hosting said data services.

The invention further provides a data signal carrying said content and having embedded therein said connection data for supply to a consumer electronics device as described above. The signal may be configured as a broadcast signal, for example a broadcast television signal. Such a television signal may include teletext data, with the connection data embedded in such teletext data, or the connection data may be carried in the vertical blanking interval of the television signal. Alternatively, the data signal may be configured as a broadcast radio signal, optionally as a broadcast FM radio signal additionally carrying RDS data, with the connection data embedded in said RDS data. As a further option, the content may comprise downloaded data from one or more web pages, with the connection data embedded (for example using watermarking techniques), for respective data services, in the data from respective web pages.

Further in accordance with the present invention there is provided a data carrying medium carrying thereon or therein a data signal as recited above. Such a medium may be, for example, an optical disc, a portable memory device (such as a so-called memory stick), with the consumer electronics device having means for accessing data from the same, or a video cassette tape: other forms of data carrying medium will readily suggest themselves to the skilled reader.

Further features of the present invention are defined in the attached claims, to which the readers attention is now directed, and the disclosure of which is incorporated herein by reference.

Additional features and advantages of the present invention, both in generic terms, and through features specific to particular presentation devices and/or forms of presented content or ancillary data, will become apparent from reading of the following description of preferred embodiments, given by way of example only, and with reference to the accompanying drawings, in which:

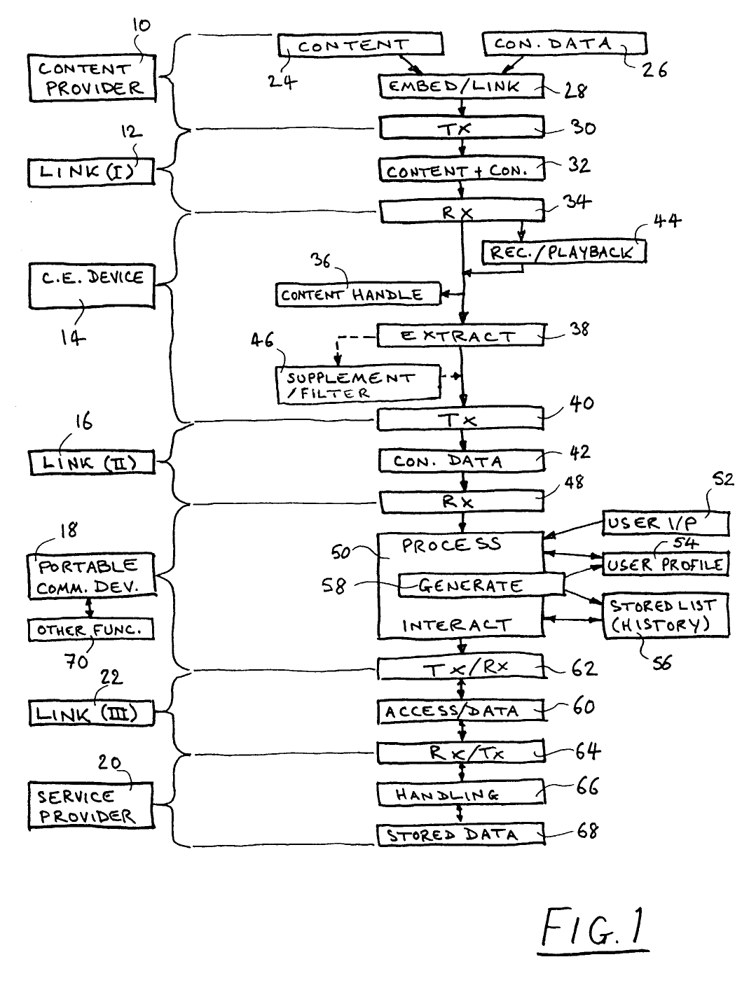

FIG. 1 schematically represents the delivery of content with connection data and the use of such connection data according to the method of the present invention;

FIG. 2 is a generalised schematic diagram of a consumer electronics device and portable communications device embodying the present invention;

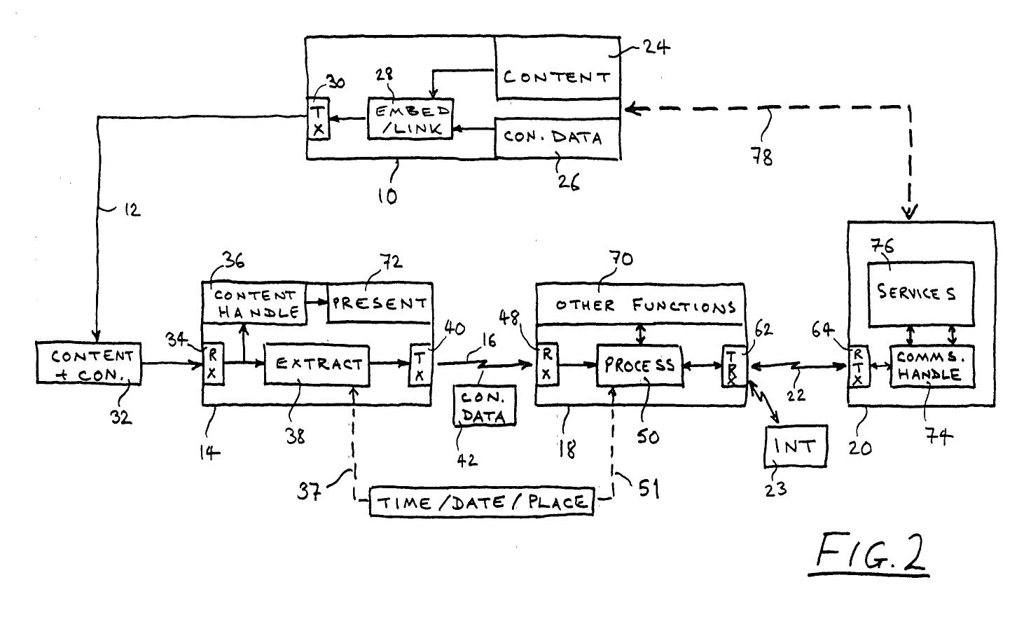

FIG. 3 represents the embedding of connection data in a stream of content for supply to the consumer electronics device in FIG. 2;

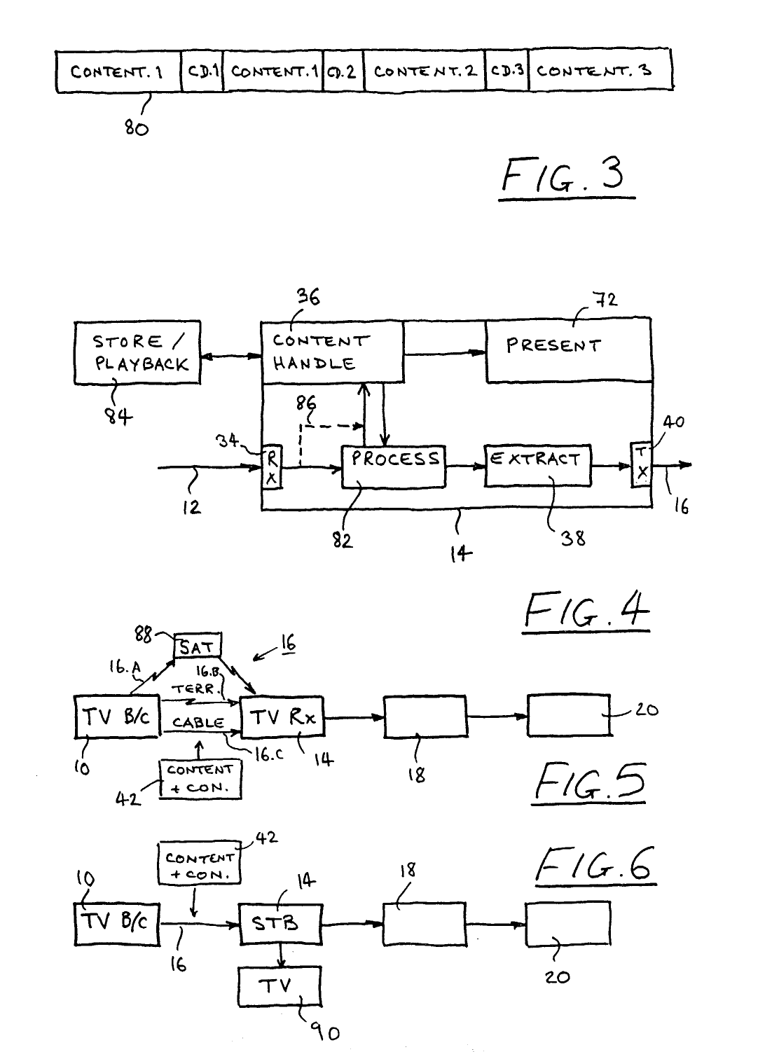

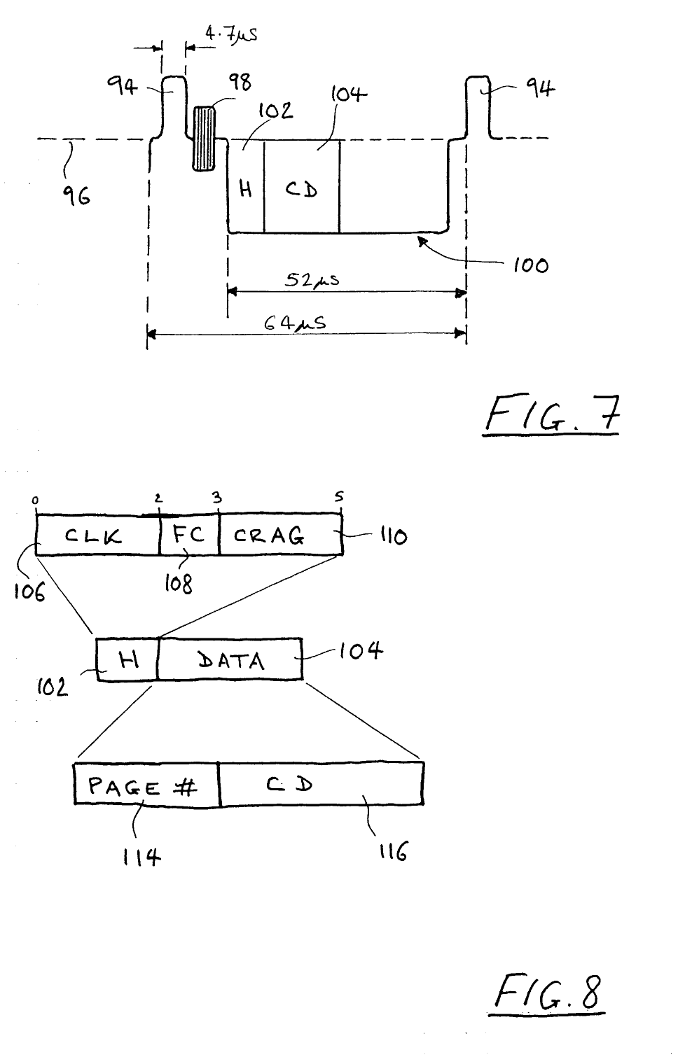

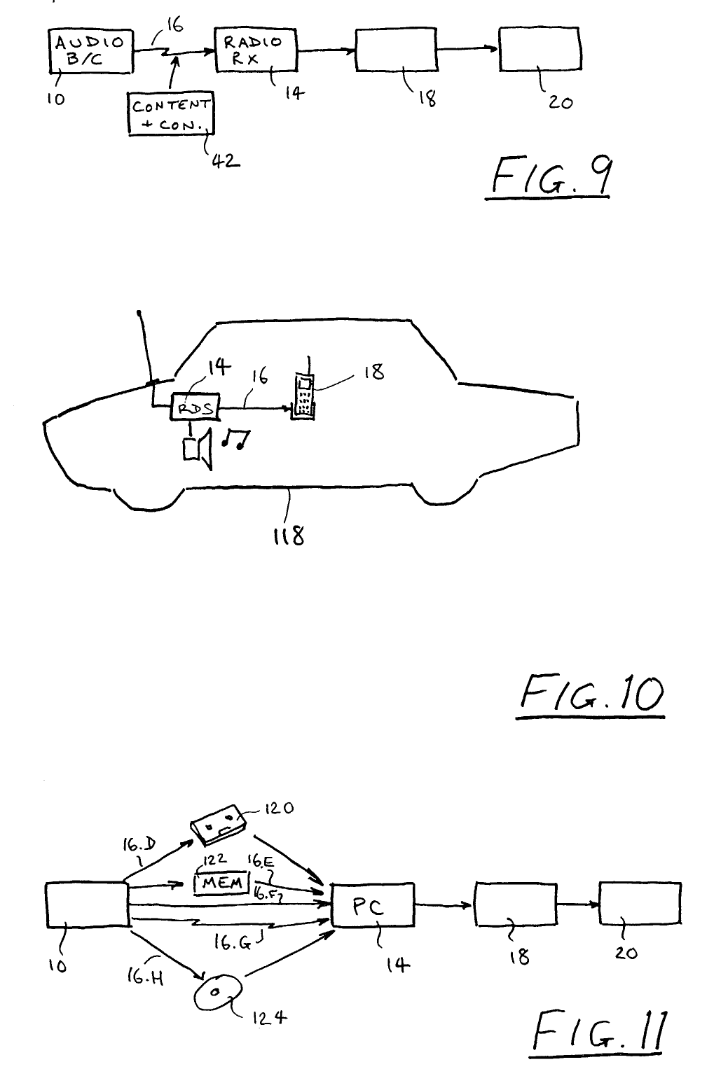

FIG. 4 schematically represents additional and alternative features for the consumer electronics device in FIG. 2;

FIG. 5 shows a first configuration of content supplier and consumer electronics device suitable to embody the invention;

FIG. 6 shows a second configuration of content supplier and consumer electronics device suitable to embody the invention;

FIG. 7 illustrates the embedding of connection data in the vertical blanking interval of a television signal;

FIG. 8 illustrates the embedding of connection data in teletext data accompanying a television signal;

FIG. 9 shows a third configuration of content supplier and consumer electronics device suitable to embody the invention;

FIG. 10 illustrates a configuration of consumer and portable devices utilising embedding of connection data in RDS data accompanying a broadcast FM radio signal;

FIG. 11 shows a fourth configuration of content supplier and consumer electronics device suitable to embody the invention;

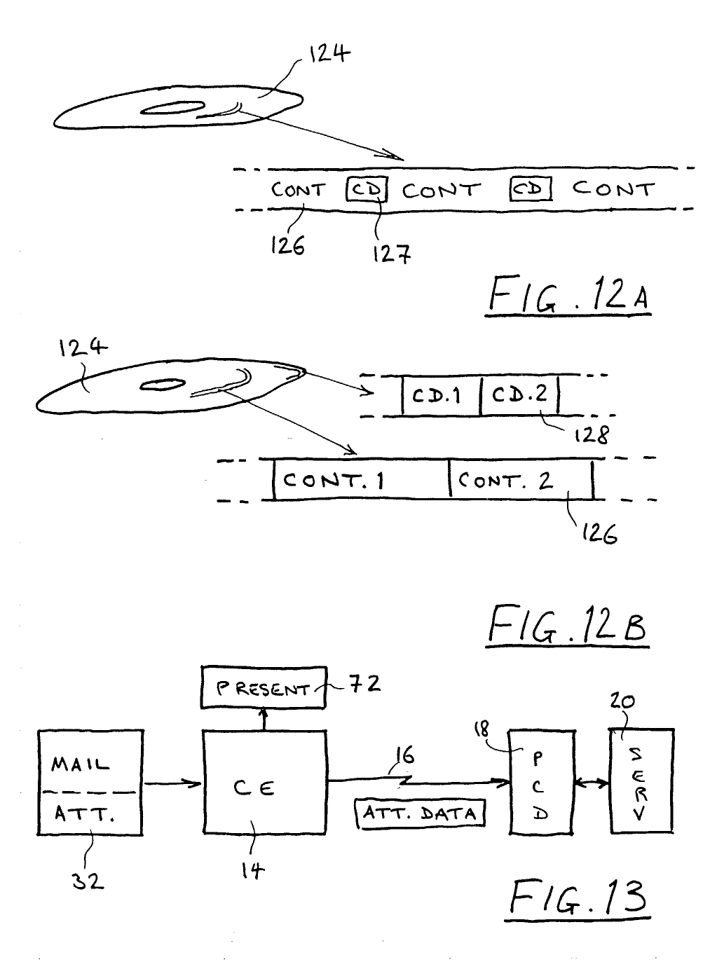

FIGS. 12A and B schematically represent a removable record carrier carrying content with, respectively, embedded and associated connection data;

FIG. 13 schematically represents the supply of content and connection data in an e-mail message format;

FIG. 14 shows a fifth configuration of content supplier and consumer electronics device suitable to embody the invention;

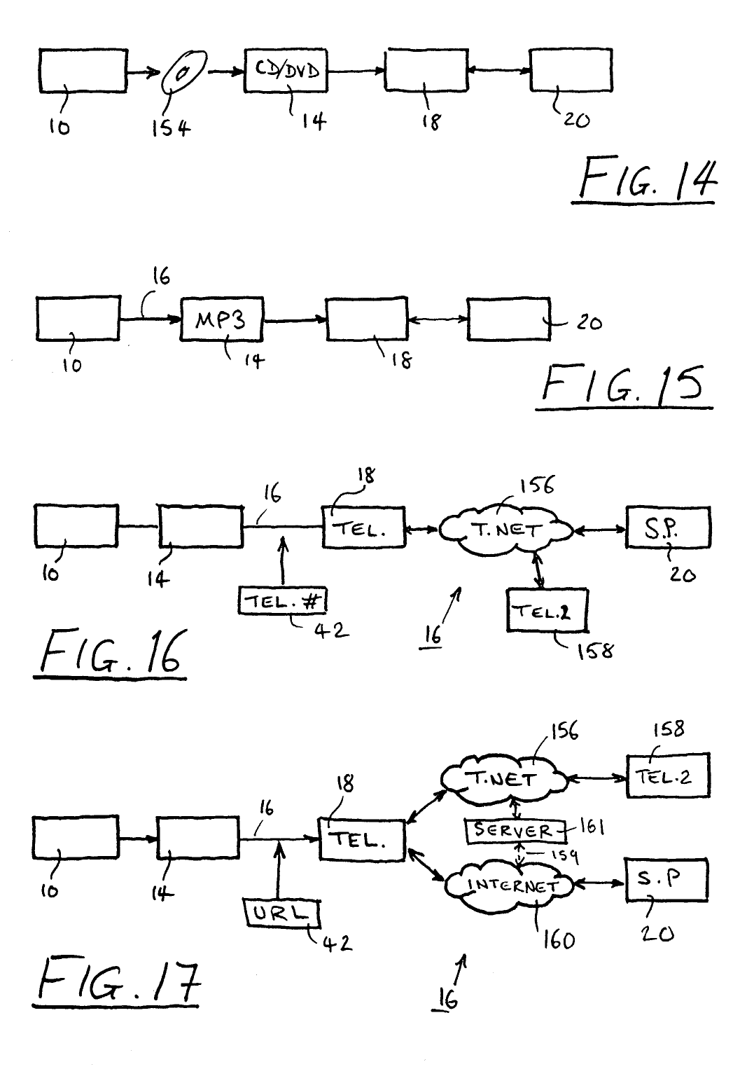

FIG. 15 shows a sixth configuration of content supplier and consumer electronics device suitable to embody the invention;

FIG. 16 shows a first configuration of portable communications device and data service provider suitable to embody the invention;

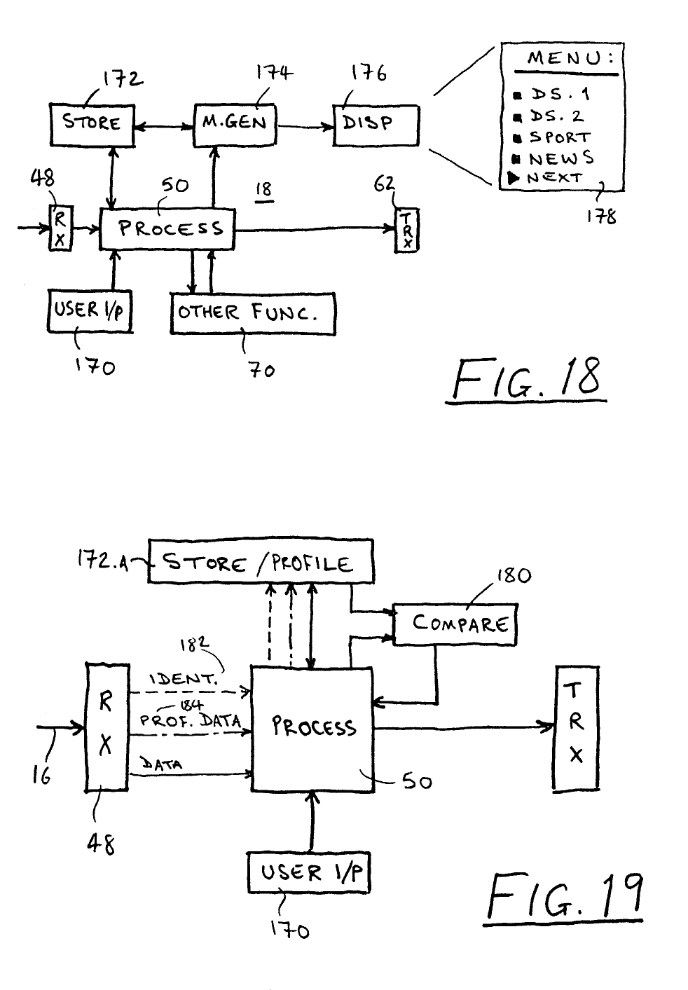

FIG. 17 shows a second configuration of portable communications device and data service provider suitable to embody the invention;

FIG. 18 schematically represents additional and alternative features for the portable communications device in FIG. 2;

FIG. 19 schematically represents further additional and alternative features for the portable communications device in FIG. 2;

FIG. 20 shows a third configuration of portable communications device and data service provider suitable to embody the invention; and

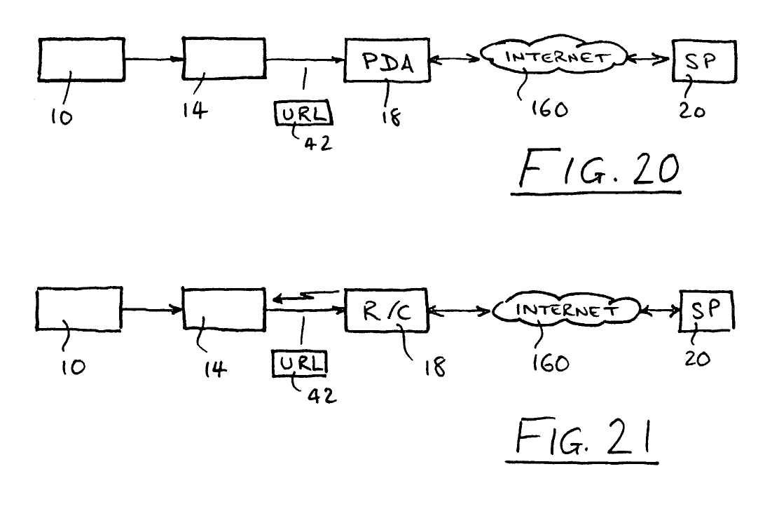

FIG. 21 shows a fourth configuration of portable communications device and data service provider suitable to embody the invention.

In the following description of preferred embodiments of the present invention, like features are designated by a common reference numeral throughout and are not separately described in detail for each such embodiment save where required for illustrating operational features of that particular embodiment. Features defined in both generic and specific implementations are identified by a reference numeral only in their generic form, and by the same reference numeral with a respective different added alphabetic suffix for each different specific implementation. Unless otherwise indicated by the context, references to items or features in the singular do not preclude the provision or use of those features in plural, and vice versa.

FIG. 1 schematically represents the delivery of content with connection data and the use of such connection data according to the method of the present invention. The chain of delivery through to use commences at content provider 10, via a first link 12 to a consumer electronics device 14, from the consumer electronics device 14 via a second link 16 to a portable communications device 18, and concludes with use in the form of interaction between the portable communications device 18 and a provider of data services 20 over a third link 22. Different forms and constructional features for the providers 10,20, devices 14, 18, and connecting links 12, 16, 22 are described below with reference to FIG. 2 et seq.

At content provider 10, a source of content 24 for the consumer electronics device 14 is provided, together with a source of connection data 26. The connection data 26 comprises such data as will enable the suitably configured portable communications device 18 to access specific data services hosted by data service provider 20, which services are related to the content delivered to the consumer electronics device 14: as an example, where the content 24 comprises a broadcast television programme, the connection data 26 may enable access to a web site carrying additional data related to the programme (such as background to a particular story line, biographies of cast and producers), access to an on-line ordering service (from which merchandise related to the programme may be ordered), or access to a telephone messaging service where the user can hear messages from, or leave messages for, members of the cast.

The content provider 10 conjoins the content 24 and connection data 26 at step 28, suitably by embedding the connection data 26 in the content 24, or by otherwise linking the two for transmission 30 over link 12 to the consumer electronics device 14. One suitable method for embedding the connection data is to include it as periodic or aperiodic data objects in a stream of other data objects carrying the content: meta data tags may then be used to identify the connection data objects and permit their subsequent extraction.

The transmitted conjoined content and connection data 32 is received at 34 by the consumer electronics device 14 and passed to content handling stage 36 which processes the received content appropriately whilst ignoring the connection data. As an example (further examples are given below), where the consumer electronics device 14 is a television receiver, the content handling will include the separation and presentation of audio and video content, decoding and making available of teletext data services, and so forth.

In one arrangement, the connection data within the conjoined content and connection data 32 is passed transparently through the consumer electronics device 14, that is to say it is passed directly from receiver 34 to an extraction stage 38 which extracts the connection data from the conjoined stream (suitably by simply ignoring everything but the connection data) and then prepares and transmits 40 the prepared connection data 42 to the portable communications device 18 via link 16. As will be understood, rather than present the content immediately on receipt, the device 14 may be able to record received content for later playback: in such a case the device is suitably arranged to record and playback 44 the received content with embedded or linked connection data. On playback of such stored or recorded data, the connection data is extracted 38 from the played back content and data whilst the content is handled 36 as before.

In an alternative to the transparent passing of the connection data from receiver 34 via the extraction stage 38 to transmission 40, the extracted connection data may be passed to a supplementing stage 46 (the links to and from which are indicated by dashed lines) which adds to, or otherwise modifies, the connection data. The supplementing may involve the adding of data gathered in the consumer electronics device identifying, for example, a television or radio station that the user has currently or recently tuned to, or other data which may be utilised in customising or otherwise scheduling services from the service provider 20. As an alternative or additional process to supplementing, the stage 46 in consumer electronics device 14 may correlate the connection data against a stored record of user preferences and prioritise or filter connection data for preferred service providers or services. This prioritisation may take the form of augmenting the connection data sent to indicate a priority, or it may take the form of the stage 46 selectively filtering non-priority items, such that only priority items are passed. Where the connection data contains some indication of the additional content available from the service provider, the filtering may be set to exclude connection to services of no interest to the user, or the facility may be used for parental control to block connection data identifying services carrying adult material.

Where there is access to a real time clock in the consumer electronics device 14 or portable communications device 18, filtering or access control may be applied on the basis of the current time and/or date, for example to make some additional content only available on special occasions such as Christmas or birthdays. For additional content of an adult nature, a watershed time (such as 9.00 pm) may be set by a parent or guardian to prevent access before this time.

Where there is access to a source of location data, filtering or access control may be applied on the basis of user location. This may take the form of selecting appropriate language for presentation of the additional content, or the making available of relevant additional content specific to the users local area (for example, the user watches a television program about history, and the additional content identified by the connection data comprises URL's for websites hosted by one or more local museums).

With filtering on the basis of time/date and/or location, it is not necessary to broadcast plural streams, each carrying different sets of connection data.

Having traversed the second link 16, the connection data 42 is received 48 by the portable communications device 18, and passed to a data processing and interaction stage 50 which is thereby enabled to establish a connection to the service or services from service provider 20 at least partially in dependence on said connection data. The accessing of data services may be automatic on receipt of the connection data or may be in response to a predetermined user input 52 to the device: the input may be a simple response to an indication that connection data has been received (e.g. a LED lights up on the portable communications device or, where it has the facility to display messages, may be a simple confirmatory response to a message such as “SERVICE CONNECT: YES/NO?”) or it may be more complex (such as requiring user selection from a menu of selected available service options, as described in greater detail hereinafter). As above, prioritisation and/or filtering may be applied within the portable device to simply delete connection data for service provider sites known to be of no interest or to block access to inappropriate sites.

The portable communications device processing and interaction stage 50 may be arranged to automatically access said data services in response to receipt of the connection data 42 from the consumer electronics device if one or more predetermined conditions are met. Such a condition may be the matching of at least a part of the connection data 42 with one or more aspects of a profile of the user 54 stored in the portable communications device. For example, where the user profile indicates an interest in sports, and the connection data includes classification of a particular data service as relating to sport, the processing stage 50 could directly establish a connection to that service (with or without first seeking user input 52), in preference to a data service for which connection data has been received, but for which no match occurs in the stored profile. Where connection data is received whilst there is no profile-matching data service currently identified, such other services may suitably be offered to the user.

In an alternative (or addition) to the use of a stored user profile 54, the portable communications device may maintain a list 56 of past user interactions with data services, so that those services known to be of interest to a user may be connected to directly when the connection data for them is next received. Whilst the profile 54 and/or list of favourite services 56 may be downloaded or otherwise input to the portable communications device, they may instead be generated 58 within the device based on a history of past interactions by the user with one or more data services.

Interaction with data services over link 22 is a two-way process with accessing commands (based on the connection data) and data 60 from the service provider 20 passing between respective transmission and receiver stages 62, 64 of the portable device 18 and service provider 20. At the service provider, from the reception/transmission stage 62, the received accessing commands are processed in a handling stage 66 with reference to stored data 68, with service data being extracted and delivered to the portable device.

As indicated generally at 70, the portable communications device 18 is additionally able to perform other functions, typically those communications or data passing functions dictated by the form of device itself (e.g. connection to telecommunications networks or remote controlling of the consumer electronics device).

FIG. 2 is a generalised schematic diagram of a system for the enabling of access to data services, comprising a content provider 10 coupled by a link 12 to a consumer electronics device 14 arranged to receive the embedded or linked content and connection data 32. The link 12 may be provided over a number of networks, such as GSM, GPRS, 3G, or cellular, and in a number of media forms, including voice data, text, video, SMS, and WML cards: other forms are described below, or will be apparent to the skilled reader.

A portable communications device 18 is provided to receive the connection data 42 from the consumer electronics device 14 via link 16 and, via link 22, to support the user interaction with the service provider 20.

The content provider 10 includes a source of content 24 for delivery to the consumer electronics apparatus 14. Where the content provider is a television or radio broadcaster, for example, the content from source 24 may suitably comprise television or radio programmes (composed live or prerecorded) for delivery via the link 12 to a consumer electronics device 14 in the form of a television, set top box, radio receiver etc. The content provider also includes a source of connection data 26 which connection data identifies a source of further information ancillary to the subject matter of respective items or sources of the content from source 24. The content provider 10 further comprises an embedding or linking stage 28 which stage is operable to put together items of content from source 24 with the appropriate connection data from source 26. This conjoined content and connection data 32 is delivered via the link 12 the form of which may include a number of variations, such as wireless, cable or satellite broadcast channels or it may be via mechanical means including the recording of the content and connection data 32 onto a storage medium (for example optical disc, video cassette tape and so forth) with the “transmission” of the content and connection data comprising the physical transfer of a removable record carrier from the content provider 10 to the—suitably configured—consumer electronics device 14.

The consumer electronics device 14 includes means 34 for receiving the transmitted content and connection data 32. The form and configuration of the receiver 34 will depend on the means by which the data is transmitted from the content provider 10. Where the data is broadcast (wirelessly or otherwise), the receiver 34 will be a suitable broadcast receiver; where the means for delivering the content and connection data is a removable record carrier, the receiver 34 will instead comprise an appropriately configured means for extracting the content and connection data from such a record carrier when received. An example of this latter arrangement would be an optical disc reader where the content and connection data are delivered on disc. Further alternative arrangements are described below.

From the receiver 34, the content is passed to content handling stage 36 and from there to a presentation stage or device 72. The nature of content handling will depend to a certain extent on the nature of the content and the requirements for processing or otherwise treating the content prior to presenting it to the user of the CE device 14. Likewise, the presentation means 72 may take a number of forms as dictated by the configuration of the CE device: for example, where the consumer electronics device 14 is an audio broadcast receiver, the content handling stage 36 may include means for digital or analogue processing of the received audio signal, and the presentation means 72 may comprise an amplifier coupled to provide an output to one or more speakers or headphones. Although CE device 14 is shown as a single device in FIG. 2, it will be readily appreciated that it could equally comprise a distributed system of interconnected devices.

Also connected to the receiver 34 within the CE device is an extraction stage 38 which receives the incoming content and connection data 32 and separates the connection data, which connection data relates to the content currently handled by stage 36. As illustrated by dashed line 37, the extraction stage 38 may be provided with a source of time/date and/or geographical location data, to enable filtering of the received connection data as described previously. The source of time/date data may be an internal clock within the device 14, or such data may be carried by (and extracted from) the received content. The source of location data may also be an internal device such as a GPS receiver or location beacon, or it may be supplied from nearby by a linked device with location determining capability. From the extraction stage 38, the connection data 42 is output via a data transmitter 40 of the consumer electronics device 14 and from there transmitted via link 16 to a receiver 48 in portable communications device 18. The link 16 may comprise a permanent or temporary wired link between transmitter 40 and receiver 48 but, preferably, it comprises a short range wireless link such as an RF or infra red link, with communications over said link 16 conforming to predetermined data protocols such as, for example, Bluetooth, 802.11, 802.15.4, Zigbee and so forth.

Within the portable communications device 18, the received connection data is passed from receiver 48 to processing stage 50 where the contained network addresses, telephone numbers or other connection data is extracted. In conjunction with transceiver 62, the processor 50 of the portable communication device is then able to establish communications with service provider 20 via further link 22 (between transceiver 62 and a further transceiver 64 of the service provider). As before, the form of link 22 may vary to include wired or wireless connections optionally via telephone or other data networks. Also, as indicated by dashed line 51, the processor may provided with a source of time/date and/or location data to enable filtering of received connection data as described above.

As will be recognised, the portable communications device will have a primary function other than supporting user interaction with the service provider 20 and, in a typical configuration, the device 18 may comprise a portable telephone, a laptop computer, a remote controller (suitably configured to control operation of the CE device 14 via wireless link—as shown in FIG. 21), or a personal digital assistant (PDA), each equipped with suitable communications facilities to support links 16 and 22. Other device types will suggest themselves to the skilled reader, and the term “portable communications device” should be construed only as requiring that a user may transport the device from place to place and that it support links 16 and 22. In the case of configuration as a portable telephone, it will be recognised that at least link 22 may be handled by the telephone's conventional communications systems if interaction with the service provider 20 takes place via a telephone connection. In FIG. 2, the other general functional features of the portable communications device 18 not contributing to the interaction with service provider 20 are indicated generally at 70.

The service provider 20 receives communications from the portable device 18 at transceiver 64 (and returns service data to the user via the same) with communications received at transceiver 64 being processed in communications handling stage 74 which in turn is coupled with a source of service data 76 forming the basis for the interaction between the user of the portable device 18 and the service provider 20. As will be recognised (and as illustrated by dashed line 78) due to the relationship of the provided services to the content being delivered to the user's consumer electronic device 14, a link is likely between the content and service providers 10, 20. Where the content provider 10 is a broadcaster, they may also create the service data 76 and either supply it to a third party service provider 20 for onward transmission to a portable device user or they may themselves act as service provider 20. It will be further recognised that, rather than the communications device 18 being directed to establish communication with service provider 20 directly, the connection data 42 forwarded from CE device 14 may instead specify an intermediary location or service (INT) 23 from which the portable communications device 18 may obtain an appropriate source address from which to obtain service data, the data from the intermediary location 23 being passed back via transceiver 62 to processor 50 and thereafter handled as connection data 42 in the manner described above. The introduction of such an intermediary step may be favoured in that it can allow upgrading of the service data and changes to the storage location thereof without requiring the connection details embedded in content 32 to be changed which can be a major advantage where the connection data is embedded in content on a prerecorded disc or other storage medium which the user may wish to replay many months (or years) after the initial creation and delivery of the content.

Turning now to FIG. 3, a data signal carrying content and with embedded connection data for supply to the CE device 14 (FIG. 2) is schematically illustrated at 80. As shown, the signal may carry differing content data (CONTENT.1, CONTENT.2, CONTENT.3) with respective connection data CD.1, 2, 3 supporting access to services and ancillary data relating to the different contents. As shown by the location of connection data CD.1, such data may be embedded within the related content or, as illustrated by CD.2 and CD.3, it may be provided in conjunction with the content for example in a message or sector header for that content stream or section. The detailed format of the signal 80 will depend on the means by which the content and connection data is transmitted over link 12 to the consumer electronics device 14 as well as the form of the content and connection data itself and some further examples of this are discussed below.

FIG. 4 shows some variations of the general configuration of the consumer electronics device 14: those features and functions identical to the arrangement of FIG. 2 will not be again described. Whereas the arrangement of FIG. 2 is set up to pass the connection data transparently through the device 14, the embodiment of FIG. 4 provides a further data processor 82 in the signal path between receiver 34 and connection data extraction stage 38. This processor 82 may be configured to provide signal treatments to the received content and connection data arriving via link 12, for example to supplement the connection data with ancillary data derived within the consumer electronics device 14, such as (for example) accumulated user profiling information, data as to which television programme a user is currently watching and so forth. This ancillary data may then accompany the connection data removed from the data stream by extraction stage 38, with this supplemental or ancillary data playing at least a part in the interaction between the user and service provider, as described in further detail below.

It may be the case that it is not desired by the user to view or listen to received content directly and, to this end, a storage/playback stage may be provided in conjunction with the content handling stage 36 to permit the user to record or time shift received content. To avoid the problem of the service connection data and content being mismatched when the content is recorded and replayed at a later date, the storage/playback stage 84 is suitably configured to receive and store the incoming content signal with embedded connection data (suitably via direct link from the receiver 34 to the content handling stage 36 as indicated by dashed line 86). As the content is replayed from storage 84, the connection data embedded therein may be passed to processor 82 and extraction stage 38 to enable the user's portable communications device 18 to establish contact with the service provider for services related to the item of content currently being replayed from store.

FIGS. 5 and 6 illustrate a number of variations in the arrangement of content provider 10 coupled to supply content and connection data to consumer electronics device 14. As shown in the embodiment of FIG. 5, the content provider may be a television broadcaster 10 with the content and connection data 42 being transmitted to the consumer electronics device in the form of a television receiver 14 via link 16. As represented, the link 16 may take a number of alternative forms, for example it may comprise a link 16.A via a satellite 88; it may comprise a terrestrial broadcast 16.B; or it may be delivered via a cable access network 16.C. As shown by FIG. 6, the receiver of the broadcast television signal may instead be a set-top box configured to provide the transparent handling of connection data (as in FIG. 2) or the facility for supplementing and processing connection data as in FIG. 4. In such cases, the presentation stage 72 within such a set top box would comprise an output to a television 90 or similar display device.

As described above with reference to FIG. 3, the connection data may be delivered to consumer electronics device 14 embedded in the content data transmitted via link 12. One suitable arrangement for this is illustrated in FIG. 7 which schematically represents the connection data being carried in a broadcast colour television signal and, specifically, in the vertical blanking interval of one or more lines thereof. The signal is of generally conventional format, with the line data starting with a sync pulse 94 above the blanking (or black) level 96 followed by a colour burst 98. In the blanking interval, indicated generally at 100, a header block of data 102 precedes and identifies the connection data 104.

In an alternative arrangement for carrying the connection data within broadcast television signals, the connection data carried within the blanking interval may be incorporated in teletext data accompanying the broadcast television signals, as represented by FIG. 8. The header block 102 consists of three separate sections, the first of which comprises 2 bytes of alternating 1's and 0's comprising a clock run-in 106 to allow for synchronisation of a reference oscillator within the teletext receiver. Following the clock run-in there is a single byte framing code 108 set at 11100100 to indicate that the following 42 bytes are to be read as data. The last section of the header comprises 2 bytes providing the control and row address group 110 which indicates which row of the displayed screen of teletext data is represented. The remaining 40 bytes are formatted as teletext data 112, including an indication of the teletext page for which they form a part. In order to allow the receiver to differentiate connection data from conventional teletext data for display, a specific page number (illustrated generally at 114) is reserved for the connection data 116 following: on identification of the particular page number in a teletext decoder, the following data is not decoded but is instead passed to transmission means 40 (FIG. 2) for onward transmission to the portable communications device.

FIG. 9 represents an alternative arrangement of content provider and consumer electronics device. In this arrangement, the content provider is an audio data broadcaster (e.g. a national or local radio station), with the content and connection data 42 being generally wirelessly transmitted over link 16 to a suitably configured radio receiver 14. There are a number of methods by which the connection data may be embedded within the transmitted content stream, for example through watermarking or modulation schemes. One particular embodiment is illustrated in FIG. 10 which represents the consumer electronics device 14 being in the form of an FM car radio, with embedding of the connection data in a radio data system (RDS) data signal received by the radio. The portable communications device 18 may be a portable telephone: for safety reasons it is preferred that the telephone is operable in a hands-free manner by the driver of the vehicle 118, and this may also permit the link 16 to be provided in a wired form whilst the user is in the car. As a further safety feature, it is preferred that the portable telephone 18 is configured to cache received connection data, rather than presenting it to the driver whilst the vehicle is in motion.

FIG. 11 illustrates further variations on the configuration of link between the content provider 10 and the consumer electronics device which may, as illustrated in this example, comprise a personal computer. Further configurations of the link include transmitting the data on audio or video tape 120 (link 16.D); transmitting the content and connection data via a removable solid state memory device 122 such as a so-called “memory stick” device (link 16.E); transmitting the data directly via hard wired fixed or permanent network link (link 16.F); transmitting the content and connection data wirelessly (link 16.G); and/or transmitting the content and connection data via some other form of memory/storage device (link 16.H) such as an optical disc 124 formatted according to a standard readable by the receiving CE device—for example formatted as a CD-ROM for supply to PC 14. As mentioned above, the connection data may be embedded within the content or it may be provided in conjunction with it at a separate and distinct location (in the case of removable record carriers or signal streams). These options are illustrated in FIGS. 12A and 12B, with FIG. 12A showing an optical disc record carrier 124 carrying thereon a stream 126 of content data, with blocks of connection data 127 embedded therein at periodic intervals. In FIG. 12B, the disc 124 again carries a stream 126 of content data, but this time the connection data is carried in a separate stream 128 appearing at a different location on the disc.

A further mechanism for the delivery and content is via e-mail, as illustrated in FIG. 13. The consumer electronics device 14, including presentation stage 72 for displaying content received in an e-mail message, may be a personal computer or a television with e-mail capability (optionally via a set-top box). The connection data, identifying a service provider supplying ancillary data to the content within the e-mail, is carried as an attachment to the e-mail, and may be in the form of one or more URL's or Java applets which are passed directly to the portable communications device 18 via the link 16.

FIGS. 14 and 15 respectively illustrate still further possible embodiments for the content provider and user's consumer electronic device. In FIG. 14, the link 12 is via a removable record carrier, in this case an optical disc 154 formatted according to a pre-defined standard such as CD or DVD with the consumer electronics apparatus 14 being in the form of a player for such discs. In FIG. 15, digital audio with embedded or associated content data is delivered from content provider 10 via wired or wireless link 16 to a suitable player: a well known and suitable format for this audio data is MP3.

Turning now to FIGS. 16 and 17, variations on the forms of, and interaction between, the portable communications device 18 and service provider 20 will now be described. In FIG. 16, the portable communications device 18 is configured as a personal portable telephone with the connection data 42 carried via link 16 from the CE device 14 being in the form of a telephone number. The telephone 18 is thereby enabled to connect to the service provider 20 via link 22, which link includes a telephone network 156 to which other telephones 158 have access. Such other telephones 158 may be similarly configured to device 18 being set up to access service data from service provider 20, as well as being able to exchange conventional telephone communications via the telephone network with device 18.

In the arrangement of FIG. 17, the portable telephone 18 is shown as having dual communications capabilities, firstly for conventional telecommunications with other such telephones 158 via telephone communications network 156, and secondly an internet access capability for supporting interactions with the service provider 20 via the internet 160. In such an arrangement, the connection data 42 embedded in the content suitably comprises a uniform resource locator (URL) for the service provider 20. As will be understood, and as shown by dashed line 159, the telephone 18 may access the internet 160 via a dial-up server 161.

Where the telephone 18 is WAP-enabled, the service provider 20 may suitably provide a WAP gateway, a specialised proxy that retrieves WML (Wireless Markup Language) documents from other web servers and compresses them before passing them to the telephone 18 to combat the typically slow download speeds. In such an arrangement, the connection data passed to the telephone suitably includes a WML URL, and the telephone may optionally check with the user before activating this URL to obtain the service connection data.

Turning now to FIG. 18, additional and/or alternative features and functions for the portable communications device 18 are shown. The device 18 includes user input means 170 in response to a predetermined operation of which the processor 50 is triggered to access one or more data services. The user input means 170 may be provided as added functions selectable by operation of existing input controls for operation of the devices other functions 70, or they may be separate/additional controls specific to the interaction with the service provider. Associated with the processor 50 is a store 172 coupled with a menu generation stage 174 which stage is coupled with a display device 176: in operation, the menu generation stage 174 generates a menu 178 on display 176 which menu is based on data from the store 172 at least partially in response to received connection data from a user's CE device. Where the received connection data identifies more than one available service, the provision of a menu enables a user to select a preferred service for interaction. As will be appreciated, the menu generation stage 174, whilst shown as a separate device, may instead be a subset of the operational functionality of processor 50. Similarly, store 172 and display 176 may be dedicated to the interaction with the service provider or may comprise existing storage/display devices of the portable device 18.

FIG. 19 illustrates yet further potential variations in the configuration of the portable device 18, this time particularly directed at automating and/or personalising the selection and accessing of services from the service provider 20. The automatic selection of a service for interaction suitably occurs in the portable communications device 18 when one or more predetermined conditions are met. In a first embodiment of this form, a storage device 172.A coupled with the processor 50 is arranged to hold profile data relating to the user of the portable device 18: on receipt by the processor of connection data identifying a particular service or services available, a comparator stage 180 (which may be a subset of the functionality of the processor 50 or may be a separate device) determines whether there is a match between the newly identified service opportunity and the stored user's profile. If there is no match then either (preferably at the users preset choice) no service connection data is passed to the portable device, or it all is, with the user then having to select from all received service opportunities. If there is a match then, rather than requesting the user to indicate whether or not he/she wishes to proceed with the service interaction, the processor is suitably configured to establish the interaction with service provider 20 without user intervention. The determination as to what constitutes a match between a service opportunity and the stored profile data may be relatively detailed in the form of an accumulated database of user preferences and characteristics against which a specification for the subject matter of the service interaction is to be compared: alternatively, the matching may be at a very simple level, merely checking an identifier for the service against a list of those which the user has previously visited. The stored profile data held in memory 172.A may comprise a list of identifiers for respective data services accessible by the portable device 18 (optionally a user selected list of “favourite” sites) with the processor automatically establishing the service connection to service provider 20 when received connection data indicates that an opportunity for interaction with such a listed site has occurred. Such a list of identifiers may be created within the portable device 18 or as indicated at 182 it may be downloaded from a remote source such as via the consumer electronics device 14. Other user profiling data indicated generally at 184, may likewise be created or accumulated within the portable device or (as shown) downloaded from an external source. Where the profile data is downloaded from the consumer electronics device, it may, for example, have been accumulated on the basis of a history of user operation of the consumer electronics device (for example a television maintaining a list of preferred channels, program genres etc.) and, as described earlier, some of this accumulated data may be used within the consumer electronics device itself to filter or otherwise reduce the number of connection data items forwarded to the portable device.

Whilst described principally in terms of a portable telephone, it will be recognised that the portable device 18 need not be so configured, requiring only that it possesses appropriate means for enabling a user to perform an interaction with the service provider, whether those means are part of the devices general functionality or are added specifically to enable the interaction. FIGS. 20 and 21 illustrate two further embodiments of portable device respectively in the form of a personal digital assistant and a remote control device—suitably one configured to operate the consumer electronics device 14. Each of these embodiments of portable device includes means for accessing the service provider 20 via the internet, consequently requiring the connection data supplied via consumer electronics device 14 to include a URL for the service provider.

In a further variant on the present invention, rather than (or in addition to) the service interaction comprising the supply of or access to web pages of data ancillary to the provided content, where the consumer electronics device 14 is configured as an internet browser, then the content itself (with embedded or associated connection data) may comprise one or more web pages or components thereof (HTML data, MPEG 1, 2 or 4 data, etc). For components such as JPEG images, where there is a certain amount of redundant data (such as a sequence of bits identifying a row of pixels of the same colour) steganographic techniques may be used to add encrypted connection data to such image data, in analogous manner to the digital watermarking of data or software.

In the foregoing, we have described a method and system for the enabling of access to data services, together with devices, record carriers and signal formats for use with the same, comprising a consumer electronics device arranged to receive content and operable to present the same to a user; and a portable communications device configured both for communications, and to access data services. Various means are provided for transmitting data from the consumer electronics device to the portable communications device. One or more services related to the content received by the consumer electronics device are provided, with connection data for the service or services being delivered to the consumer electronics device in conjunction with the content. The connection data is transmitted therefrom to the portable communications device, with the portable communications device being operable to establish a connection to access the service or services at least partially in dependence on the connection data.

Although defined principally in terms of a software-based or controlled implementation, the skilled reader will be well aware than many of the above-described functional features could equally well be implemented in hardware or a combination of software and hardware.

From reading the present disclosure, other modifications will be apparent to persons skilled in the art. Such modifications may involve other features which are already known in the design, manufacture and use of consumer electronics devices, portable telecommunications devices and/or data network access apparatus and devices and component parts thereof and which may be used instead of or in addition to features already described herein.

1. A method for the enabling of user access to data services by a portable communications device configured both for communications and to access such data services, wherein a consumer electronics device is arranged to receive content and present the same to a user; and
wherein one or more services related to said content received by said consumer electronics device are provided, with connection data for said service or services being delivered to said consumer electronics device in conjunction with said content, said connection data being transmitted therefrom to said portable electronics device, and said portable communications device being thereby enabled to establish a connection to said service or services at least partially in dependence on said connection data.

2. A method as claimed in claim 1, wherein said connection data is embedded in said content.

3. A method as claimed in claim 1, wherein said connection data is passed transparently through said consumer electronics device to said portable communications device.

4. A method as claimed in claim 1, wherein said connection data is supplemented in said consumer electronics device prior to being passed to said portable communications device.

5. A method as claimed in claim 1, wherein said content and service data are stored in said consumer electronics device following receipt thereof, with said connection data being transmitted to said portable communications device on reading of said content and service data from storage.

6. A method as claimed in claim 1, wherein said portable communications device accesses said data services in response to a predetermined user input thereto.

7. A method as claimed in claim 1, wherein said portable communications device is arranged to automatically access said data services in response to receipt of said connection data from said consumer electronics device if one or more predetermined conditions are met.

8. A method as claimed in claim 7, wherein a predetermined condition to be met is the matching of at least a part of the connection data with one or more aspects of a profile of the user stored in the portable communications device.

9. A method as claimed in claim 8, wherein said profile of the user is generated within said portable communications device based on a history of past interactions by the user with said one or more data services.

10. A method as claimed in claim 7, wherein a predetermined condition to be met is the matching of at least a part of the connection data with one or more data items in a stored list held in the portable communications device.

11. A method as claimed in claim 10, wherein said one or more data items in a stored list are generated within said portable communications device based on a history of past interactions by the user with said one or more data services.

12. A system for the enabling of access to data services, comprising:
a consumer electronics device arranged to receive content and operable to present the same to a user; and
a portable communications device configured both for communications and to access data services, with the system including means for transmitting data from said consumer electronics device to said portable device;
wherein one or more services related to said content received by said consumer electronics device are provided, with connection data for said service or services being delivered to said consumer electronics device in conjunction with said content, said connection data being transmitted therefrom to said portable communications device, and said portable communications device being operable to establish a connection to access said service or services at least partially in dependence on said connection data.

13. A system as claimed in claim 12, wherein said consumer electronics device is arranged to pass said connection data transparently through to said portable communications device.

14. A system as claimed in claim 12, wherein said consumer electronics device is configured to supplement said connection data prior to passing it to said portable communications device.

15. A system as claimed in claim 12, wherein said consumer electronics device is configured to filter said connection data on the basis of preset criteria and pass to the portable communications device only such of said connection data as meets said criteria.

16. A system as claimed in claim 15, wherein said preset criteria comprises data defining a profile of a user of the system.

17. A system as claimed in claim 15, wherein said consumer electronics device includes a source of time and/or date information, and said preset criteria for at least some received connection data comprises a time/date window outside which said connection data is not transmitted to said portable communications device.

18. A system as claimed in claim 15, wherein said consumer electronics device has access to a source of data defining the geographical location thereof, and said preset criteria for at least some received connection data comprises a specified area within which the consumer electronics device is to be located if said connection data is to be transmitted to said portable communications device.

19. A system as claimed in claim 12, wherein said consumer electronics device is operable to store said content and service data following receipt thereof, said consumer electronics device being arranged to transmit said connection data to said portable device on reading of said content and service data from storage.

20. A system as claimed in claim 12, wherein said means for transmitting data from said consumer electronics device to said portable device is a wireless link.

21. A consumer electronics device for use in a system for the enabling of access to data services, comprising said consumer electronics device arranged to receive content and operable to present the same to a user, and a portable communications device configured both for communications and to access data services, with the consumer electronics device including means for transmitting data therefrom to said portable device;
wherein one or more services related to said content received by said consumer electronics device are provided, with connection data for said service or services being delivered to said consumer electronics device in conjunction with said content, said consumer electronics device being configured to transmit said connection data therefrom to said portable communications device.

22. A consumer electronics device as claimed in claim 21, being arranged to pass said connection data transparently through to said portable communications device.

23. A consumer electronics device as claimed in claim 21, being configured to supplement said connection data prior to passing it to said portable communications device.

24. A consumer electronics device as claimed in claim 21, being configured to filter said connection data on the basis of preset criteria and pass to the portable communications device only such of said connection data as meets said criteria.

25. A consumer electronics device as claimed in claim 21, further comprising storage means arranged to store received content and associated connection data.

26. A consumer electronics device as claimed in claim 21, configured as broadcast receiver, wherein said connection data is embedded in a broadcast signal carrying said content and received by said device.

27. A consumer electronics device as claimed in claim 26, configured as a television receiver, wherein said connection data is embedded in a broadcast television signal carrying broadcast content received by said device.

28. A consumer electronics device as claimed in claim 21, configured as a set-top box, wherein said connection data is embedded in a broadcast television signal carrying broadcast content received by said device.

29. A consumer electronics device as claimed in claim 27, wherein said connection data is carried in the vertical blanking interval portion of said broadcast television signal.

30. A consumer electronics device as claimed in claim 27, wherein said connection data is embedded in teletext data accompanying said broadcast television signal.

31. A consumer electronics device as claimed in claim 26, configured as a radio receiver, wherein said connection data is embedded in a broadcast audio and data signal carrying broadcast content received by said device.

32. A consumer electronics device as claimed in claim 31, wherein said broadcast audio and data signal is an FM radio broadcast signal accompanied by RDS data, and said connection data is embedded in said RDS data.

33. A consumer electronics device as claimed in claim 21, configured as an optical disc player and arranged to extract said connection data from a received optical disc.

34. A portable communications device for use in a system for the enabling of access to data services by said device, and comprising a consumer electronics device arranged to receive content and operable to present the same to a user, and said portable communications device configured both for communications and to access data services, with said portable communications device including means for receiving data transmitted from said consumer electronics device thereto;
wherein one or more services related to said content received by said consumer electronics device are provided, with connection data for said service or services being delivered to said consumer electronics device in conjunction with said content, said connection data being transmitted therefrom to said portable electronics device, and said portable communications device being operable to establish a connection to access said service or services at least partially in dependence on said connection data.

35. A portable communications device as claimed in claim 34, wherein said connection data comprises an identifier for a location from which further data specifying a connection location for access to said data services.

36. A portable communications device as claimed in claim 34, configured as a portable telephone, wherein said connection data comprises a telephone number.

37. A portable communications device as claimed in claim 34, is configured as a portable telephone and further comprises means enabling internet access, wherein said connection data comprises a Uniform Resource Locator.

38. A portable communications device as claimed in claim 34, having user input means, wherein said portable communications device is configured to access said data services in response to a predetermined user input via said user input means.

39. A portable communications device as claimed in claim 38, being configured to generate and present to a user a menu of user-selectable options related to said data services and said predetermined user input comprises selection of an item from said menu.

40. A portable communications device as claimed in claim 34, being configured to automatically access said data services in response to receipt of said connection data from said consumer electronics device if one or more predetermined conditions are met.

41. A portable communications device as claimed in claim 40, further comprising memory means holding profile data related to a user, wherein the or one of the predetermined conditions to be met is the matching of at least a part of the connection data with one or more aspects of said stored profile of said user.

42. A portable communications device as claimed in claim 41, including means to receive said profile data transmitted from said consumer electronics device.

43. A portable communications device as claimed in claim 41, including monitoring means arranged to generate said profile of the user based on a history of past interactions by the user with said one or more data services.

44. A portable communications device as claimed in claim 40, further comprising memory means holding a list of identifiers for respective data services accessible by said portable communications device, wherein the or one of the predetermined conditions to be met is the matching of at least a part of the connection data with an identifier stored in said list.

45. A portable communications device as claimed in claim 34, configured to filter said connection data on the basis of preset criteria and to access only those of said service or services for which said connection data meets said criteria.

46. A portable communications device as claimed in claim 45, including a source of time and/or date information, and said preset criteria for at least some received connection data comprises a time/date window outside which said service or services are not accessed.

47. A portable communications device as claimed in claim 45, having access to a source of data defining the geographical location thereof, and said preset criteria for at least some received connection data comprises a specified area within which the portable communications device is to be located if said service or services are to be accessed.

48. A portable communications device as claimed in claim 34, configured as a personal digital assistant with communications facilities for accessing the internet, wherein said connection data specifies one or more Uniform Resource Locators for respective web sites hosting said data services.

49. A portable communications device as claimed in claim 34, configured as a remote controller for said consumer electronics device with communications facilities for accessing the internet, wherein said connection data specifies one or more Uniform Resource Locators for respective web sites hosting said data services.

50. A data signal carrying said content and having embedded therein said connection data for supply to a consumer electronics device as claimed in claim 21.

51. A data signal as claimed in claim 50, configured as a broadcast television signal

52. A data signal as claimed in claim 51, including teletext data, wherein said connection data is embedded in said teletext data.

53. A data signal as claimed in claim 51, wherein said connection data is carried in the vertical blanking interval of the television signal.

54. A data signal as claimed in claim 50, configured as a broadcast radio signal.

55. A data signal as claimed in claim 54, configured as a broadcast FM radio signal additionally carrying RDS data, wherein said connection data is embedded in said RDS data.

56. A data signal as claimed in claim 50, wherein said content comprises downloaded data from one or more web pages, and said connection data is embedded, for respective data services, in the data from respective web pages.

57. A data carrying medium carrying thereon or therein a data signal as claimed in claim 50.

58. A data carrying medium as claimed in claim 57, in the form of an optical disc.

59. A data carrying medium as claimed in claim 57, in the form of a portable memory device, with the consumer electronics device having means for accessing data from the same.

60. A data carrying medium as claimed in claim 57, in the form of a video cassette tape.
